(19) United States
(12) Patent Application Publication
(10) Pub. No.: US 2024/0084485 A1
(43) Pub. Date: Mar. 14, 2024

(54) Co-Filament, Roving, Yarn, Semi-Finished Product, Use of a Co-Filament and Method for Producing a Co-Filament

(71) Applicant: Fibrecoat GmbH, Aachen (DE)

(72) Inventors: Richard Haas, Aachen (DE); Robert Brüll, Würselen (DE); Alexander Lüking, Aachen (DE)

(21) Appl. No.: 18/273,652

(22) PCT Filed: Sep. 24, 2021
(86) PCT No.: PCT/EP2021/076363

§ 371 Date: Jul. 21, 2023

(30) Foreign Application Priority Data
Jan. 25, 2021 (DE) 10 2021 101 494.8

(51) Int. Cl. D01F 9/08; D01F 8/18

(52) U.S. Cl. CPC D01F 9/08; D01F 8/18; D10B 2101/02; D10B 2101/20

(57) ABSTRACT

The invention relates to a co-filament comprising a first filament and a second filament, wherein the first filament consists of an inorganic substance, wherein the first filament has a glass transition temperature of greater than or equal to 400° C., wherein the second filament consists of a metallic material, the second filament contacting the first filament. Furthermore, the invention relates to a roving, a yarn and a semi-finished product comprising this co-filament, a use of this co-filament and a method for producing this co-filament.

The invention relates to a co-filament, a roving, a yarn, a semi-finished product, a use of a co-filament and a method for producing a co-filament.

In particular, the invention relates to a co-filament comprising a first filament made of an inorganic substance and a second filament made of a metallic material.

Filaments have a steadily increasing importance in the art. This is accompanied by the growing spectrum of properties, which have filaments known in the prior art.

In particular in the field of automotive engineering, aircraft and spacecraft technology and filtration, in particular in catalysts, there is a need for high-temperature-resistant and cost-effective filaments, which are additionally also conductive for heat and/or electrical current.

Various products of filaments are used in the region of the thermally and/or electrically conductive filaments for conducting electrical currents and/or for shielding electromagnetic waves, for conducting heat, for forming antennas and the like:

Pure multifilament metal fibers are expensive to manufacture due to the production method, in particular the strand drawing method, with 100-800 €/kg, in particular if the filament diameter is less than 50 micrometers.

Polymer fibers coated with silver or aluminum are also not relevant for many applications due to the two-stage and slow production process with 200-500 €/kg. In addition, the continuous use temperature due to the polymer used, in particular 80° C. for PA6, is not sufficient for applications in the field of engines.

Carbon fibers are of economic interest with 10-100 €/kg for many applications, but the conductivity is not sufficient in particular for electromagnetic shielding.

For some applications, for example in the region of electromagnetic shielding, textiles are also coated flat, subsequently galvanically with silver, copper or aluminum. This layer can form cracks during draping, which in turn act as antennas and prevent shielding, the same applies to films. Films, sheets and plates do not provide sufficient draping and formability for components or spaces nor the possibility for air to penetrate this layer, which makes it more particularly difficult to cool devices or rooms.

The object of the invention is that of providing an improvement over or an alternative to the prior art.

According to a first aspect of the invention, the object is achieved by a co-filament comprising a first filament and a second filament, wherein the first filament consists of an inorganic substance, wherein the first filament has a glass transition temperature of greater than or equal to 400° C., wherein the second filament consists of a metallic material, wherein the second filament contacts the first filament.

In this regard, the following is explained conceptually:

First of all, it should be expressly pointed out that in the context of the present patent application indefinite articles and numerical indications such as “one”, “two”, etc. are as a rule to be understood as “at least” indications, i.e. as “at least one . . . ”, “at least two . . . ”, etc., unless it is expressly clear from the respective context or it is obvious or technically imperative to the person skilled in the art that only “exactly one . . . ”, “exactly two . . . ”, etc. can be meant there.

In the context of the present patent application, the expression “in particular” should always be understood as introducing an optional, preferred feature. The expression should not be understood to mean “specifically” or “namely.”

A “co-filament” describes a fiber or also a filament with a practically endless length, which has at least two partial filaments of different material properties extending in the longitudinal direction, wherein the two materially different filaments are physically and/or chemically connected to one another to form the co-filament. In particular, a co-filament has a ratio of length to diameter of greater than or equal to 1000.

A “first filament” is understood to mean an elementary fiber made of an inorganic substance which has been produced from a nozzle, in particular by means of a nozzle method or a spinning method. A “second filament” is understood to mean a fiber which by means of adhesion of a metallic melt has been produced on the first filament and solidification on the first element. In other words, a filament describes a fiber with practically endless length.

The first filament may consist of an inorganic and non-metallic material. The second filament may consist of an organometallic material. An “organometallic substance” is understood to mean a substance in which an organic radical or an organic compound is bonded directly to a metal atom. It should be expressly pointed out that a metallic substance and/or an organometallic material do not have a glass transition temperature within the meaning of this description.

Preferably, the co-Filament and thus also both the first filament and the second filament have a length of greater than or equal to 10 cm, preferably a length of greater than or equal to 1 m and particularly preferably a length of greater than or equal to 10 m.

The first filament may be directly connected to the second filament. In particular, the co-filament has no material deviating from the first and second filament at the transition between the first filament to the second filament. Preferably, the first filament and the second filament are not connected to one another by means of a composite, in particular not with a composite having synthetic resin or the like. Preferably, the co-filament has only residues of atmospheric moisture at the transition between the first filament to the second filament.

Preferably, a co-filament consists of a first filament and a second filament. In particular, the co-filament has no further substances next to the first filament and the second filament, in particular no smoother.

The first filament is preferably not pre-treated before the adhesion of the second filament to the first filament, in particular not pre-treated under the action of a substance deviating from the material of the first filament and/or second filament.

When the second filament is adhered to the first filament, the first filament preferably has a temperature that is greater than the ambient temperature. Preferably, when the second filament is adhered to the first filament, the first filament has a temperature of greater than or equal to 40° C., preferably a temperature of greater than or equal to 50° C. and particularly preferably a temperature of greater than or equal to 60° C., wherein the temperature from the first heat results with which the first filament is shaped. When the second filament is adhered to the first filament, the first filament preferably has a temperature which results from the first heat with which the first filament is shaped. In particular, the first filament is not heated before the adhesion of the second filament to the first filament.

Before the second filament is adhered to the first filament, the first Filament can have an age after the primary filament has been originally formed of less than or equal to 1 second, preferably an age of less than or equal to 0.5 seconds and particularly preferably an age of less than or equal to 0.1 seconds. Advantageously, this prevents or prevents the first filament from being able to react with the surrounding air humidity prior to adhering the second filament to the first filament.

An “inorganic substance” is understood to mean a substance which does not contain any plant or animal constituents or includes them only to a lesser extent as impurities. In particular, an inorganic substance is understood to mean a natural stone, in particular granite, basalt, shale, sandstone or limestone. An inorganic substance is preferably understood to mean a substance which does not have carbon or only to a small extent as an impurity. An inorganic substance preferably means a ceramic, a crystalline glass or an amorphous glass, in particular an E-glass, an S-glass or a C-glass.

A “metallic material” denotes a substance which is in particular in the periodic table of the elements on the left and below a separation line of boron to astat.

In addition to this substance, a “filament consisting of a material” can also have impurities, in particular impurities that are caused by process engineering. Furthermore, it is also possible, inter alia, to use a mixed metal which consists of a plurality of metallic materials. In particular, a mixed metal has impurities only to a minor extent.

The “glass transition temperature” of a substance, in particular a glass, a polymer or a ceramic, describes the temperature at which the substance changes from its solid aggregate state to a viscous or liquid state.

Here, a co-filament comprising two chemically and/or physically connected filaments of different material is proposed, wherein the first filament consists of an inorganic substance and the second filament consists of a metallic material.

In this way, a combination of the material properties of the different filaments in a co-filament can advantageously be achieved.

Preferably, the battery shell has a glass transition temperature greater than or equal to 500° C., more preferably a glass transition temperature greater than or equal to 570° C., and most preferably glass transition temperature greater than or equal to 600° C.

The co-filament has a first inorganic filament, whereby a high tensile strength, in particular a tensile strength of more than 500 N/mm, for the co-filament ²and a high modulus of elasticity, in particular a modulus of elasticity of more than 55,000 N/mm 2 can be achieved.

The co-filament has a metallic second filament, whereby a particularly advantageous conductivity for heat and/or electrical current can be achieved, in particular an electrical conductivity with an electrical resistance of the co-filament of less than 200 Ω/m.

According to a preferred embodiment, the metallic second filament can achieve an electrical resistance of the co-filament of less than 150 Ω/m, preferably an electrical resistance of the co-filament of less than 110 Ω/m, and particularly preferably an electrical resistance of the co-filament of less than 75 Ω/m. Further preferably, by means of the metallic second filament, an electrical resistance of the co-filament of less than 50 Ω/m can be achieved, preferably an electrical resistance of the co-filament of less than 30 Ω/m, and particularly preferably an electrical resistance of the co-filament of less than 20 Ω/m. Particularly preferably, the metallic second filament can achieve an electrical resistance of the co-filament of less than 10 Ω/m, preferably an electrical resistance of the co-filament of less than 8 Ω/m and particularly preferably an electrical resistance of the co-filament of less than 5 Ω/m.

The linkage of the first inorganic filament to the second metallic filament further enables excellent impact resistance, as a result of which the proposed co-filament is well suited for ballistic applications. In addition, an excellent thermal resistance of the co-filament results, in particular depending on the material composition of the co-filament, and good light resistance. It was shown that the proposed co-filament has a temperature resistance up to at least 400° C., preferably up to at least 500° C. and particularly preferably up to at least 600° C.

Due to the high temperature resistance, the co-filament can be used in warm ambient conditions, in particular in the vicinity of motors. The thermal conductivity also enables the heat to be discharged via the co-filament, in particular a cooling of an engine.

In addition, the co-filament proposed here achieves particularly good values for fatigue resistance and corrosion resistance.

The co-filament proposed here preferably consists only of naturally occurring materials and is thus particularly environmentally friendly. In particular, the co-filament can be recycled completely chemically and/or physically.

Furthermore, the co-filament proposed here has a better chemical resistance than E-glass.

The co-filament is also extremely flexible and can be processed further to form a textile or a textile semi-finished product.

A textile or a textile semi-finished product can be fiber-based, in particular a nonwoven. A textile or a textile semi-finished product can be textile-based, in particular a knitted fabric, preferably a knitted fabric or interlaced yarns. Textile or a textile semi-finished product can be textile-based, in particular an extended thread system, preferably a non-crimp fabric or a tape. Textile or a textile semi-finished product can be textile-based, in particular a crossed thread system, preferably a woven fabric or a mesh. The semi-finished products from the co-filament remain flexible in such a way that they can be draped in virtually any desired final form at their designated site.

It can advantageously be achieved in the case of a nonwoven that the nonwoven has a particularly good thermal insulation effect, in particular by the influence of the first inorganic filament.

In addition, the co-filament can also be further processed to form a filter fabric and/or a filter web. As a result of the very thin maximum transverse extension of the co-filament of less than or equal to 23 μm, a particularly fine filter medium for small particles can be achieved, which, however, can continue to be penetrated by air.

It is specifically proposed here that the first filament is shaped in the production of the co-filament by means of a nozzle method or a spinning method and is subsequently brought into contact with a molten metal. The metal solidifies in contact with the first filament, thereby producing the co-filament. As a result of this production, a particularly stable adhesion of the two filaments to one another can be achieved, wherein the second filament is physically and/or chemically connected to the first filament. Physically, the filaments are connected to one another by means of static friction. Chemically, an electrostatic adhesion of the metallic second filament to the molecules of the inorganic first filament may occur. Furthermore, a covalent bonding of the metallic second filament to the molecules of the inorganic first filament may occur.

The adhesion of the second filament to the first filament advantageously makes it possible for the co-filament not to be broken down in a washing process, in particular the metallic second filament is not washed by the inorganic first filament.

By combining the material properties of the first filament with the material properties of the second filament, a co-filament can advantageously be achieved, which has novel material properties compared to the known filaments, in particular a better chemical bonding, a high-temperature resistance, a particularly high tensile strength and a high chemical resistance in combination with an excellent conductivity for heat and/or electrical current. Furthermore, a reflection effect can advantageously be achieved by the different material combination, in particular by the second metallic filament.

The co-filament proposed here can be produced cost-effectively, in particular by means of the method according to the fifth aspect of the invention. Due to the low price, existing products can be substituted on the Basis of the proposed co-filament and new fields of application can be made available. In addition, novel applications can be developed in the field of lightweight construction.

According to an expedient embodiment, the first filament has a glass transition temperature of greater than or equal to 660° C., preferably a glass transition temperature of greater than or equal to 800° C. and particularly preferably a glass transition temperature of greater than or equal to 1000° C.

Preferably, the first filament has a glass transition temperature of greater than or equal to 700° C., preferably a glass transition temperature of greater than or equal to 800° C., and particularly preferably a glass transition temperature of greater than or equal to 900° C. Further preferably, the first filament has a glass transition temperature of greater than or equal to 950° C., preferably a glass transition temperature of greater than or equal to 1050° C. and particularly preferably a glass transition temperature of greater than or equal to 1100° C.

The specified glass transition temperature of the first filament of an inorganic substance advantageously makes it possible for the first filament to have a particularly good temperature resistance, so that, among other things, metallic substances having a comparatively high melting point to a second filament can also be used in a molten liquid adhering to the first filament of the co-filament, whereby co-filaments with particularly preferred material properties can be achieved.

It should be expressly noted that the above values for the width of the outer stiffening means should not be understood as strict limits; rather, it should be possible to exceed or fall below them on an engineering scale without departing from the described aspect of the invention. In simple terms, the values are intended to provide a guide to the size of the glass transition temperature proposed here for the first filament.

Preferably, the first filament has a bound oxygen content of greater than or equal to 30% by mass, preferably a bound oxygen content of greater than or equal to 40% by mass and particularly preferably a bound oxygen content of greater than or equal to 44% by mass.

Further preferably, the first filament has a bound oxygen content of greater than or equal to 35% by mass, preferably a bound oxygen content of greater than or equal to 42% by mass and particularly preferably a bound oxygen content of greater than or equal to 45% by mass.

In this regard, the following is explained conceptually:

The “bonded oxygen portion” of the first filament is understood to mean the sum of the entire bound oxygen contained in the first filament, in particular the sum of the bound oxygen of any molecules contained in the inorganic first filament.

In experiments it was shown that the specified range of the bound oxygen fraction is particularly advantageous for the adhesion between the second filament and the first filament. As a result, a particularly robust co-filament can be achieved.

It should be expressly pointed out that the above values for the bonded oxygen content of the first filament should not be understood as strict limits, but rather they should be able to be exceeded or fallen below on an engineering scale without departing from the described aspect of the invention. In simple terms, the values are intended to provide an indication of the size of the bonded oxygen content of the first filament proposed here.

According to a particularly expedient embodiment, the first filament has a silicon dioxide fraction of greater than or equal to 45% by mass, preferably a silicon dioxide fraction of greater than or equal to 50% by mass and particularly preferably a silicon dioxide fraction of greater than or equal to 55% by mass.

Silicon dioxide is a network former that forms the basic molecular structure of the inorganic first filament. The abovementioned fraction makes it possible to improve the material properties of the inorganic first filament, in particular to improve the mechanical properties, in particular the tensile strength and/or the modulus of elasticity.

Tests have shown that the above-specified range of the silicon dioxide fraction can, among other things, increase the temperature resistance and the temperature change resistance of the co-filament.

It should be expressly pointed out that the above values for the silicon dioxide content of the first filament should not be understood as strict limits, but rather they should be able to be exceeded or fallen below on an engineering scale without departing from the described aspect of the invention. In simple terms, the values are intended to provide an indication of the size of the range proposed for the silicon dioxide content of the first filament.

Further preferably, the first filament has an aluminum oxide content of greater than or equal to 60%, more preferably an aluminum oxide content greater than or equal to 70%, and most preferably an aluminum oxide content greater than or equal to 80%.

Aluminum oxide is exactly like silicon dioxide a network former which forms the molecular basic structure of the inorganic first filament. The proportion of the aluminum oxide supports the positive properties of the first filament, in particular the mechanical properties, in particular the tensile strength and/or the modulus of elasticity.

If the metallic material used for the second filament aluminum is used, the adhesion between the inorganic first filament and the second filament made of aluminum can be improved particularly advantageously by a high proportion of the aluminum oxide in the first filament.

In particular, the aluminum oxide enables a direct chemical bonding of aluminum, provided aluminum is used as metallic material for the second filament.

It should be expressly pointed out that the above values aluminum oxide content of the first filament should not be understood as strict limits, but rather they should be able to be exceeded or fallen below on an engineering scale without departing from the described aspect of the invention. In simple terms, the values are intended to provide an indication of the size of the range proposed here of the aluminum oxide content of the first filament.

According to an expedient embodiment, the first filament has a boron trioxide fraction of less than or equal to 0.5% by mass, preferably a boron trioxide fraction of less than or equal to 0.1% by mass and particularly preferably a boron trioxide fraction of less than or equal to 0.01% by mass.

Boron trioxide is classified as a hazardous substance according to an EU chemical ordinance. In this respect, a small boron trioxide content is advantageous.

Particularly preferably, the first filament has no detectable amount of boron trioxide.

It should be expressly pointed out that the above values for boron trioxide content should not be understood as strict limits, but rather they should be able to be exceeded or fallen below on an engineering scale without departing from the described aspect of the invention. In simple terms, the values are intended to provide an indication of the range of the boron trioxide content of the first filament proposed here.

According to a preferred embodiment, the first filament has a magnesium oxide content of less than or equal to 10% by mass, preferably a magnesium oxide content of less than or equal to 7% by mass and particularly preferably a magnesium oxide content of less than or equal to 5% by mass.

It was shown in experiments that an increasing magnesium oxide content improves the surface tension of the inorganic starting material for the first filament in its liquid phase, whereby the drawing ability of the first filament in its liquid phase can be improved. Furthermore, the crystallization is suppressed with an increasing magnesium dioxide content. In addition, an increasing magnesium oxide content makes it possible to increase the hardness of the first filament. Moreover, the temperature change resistance of the first filament can be improved by an increasing magnesium oxide content, in particular since an increasing magnesium oxide content reduces the thermal expansion of the first filament. It was also possible to show that the water and/or acid resistance of the first filament can be improved by an increasing magnesium oxide content and that an increasing magnesium oxide content facilitates the expansion (cooling) of the glass. Furthermore, the first filament according to an expedient embodiment has a calcium oxide fraction of less than or equal to 20% by mass, preferably a calcium oxide fraction of less than or equal to 10% by mass and particularly preferably a calcium oxide fraction of less than or equal to 8% by mass.

With regard to the calcium oxide fraction in the first filament, it was shown in experiments that an increasing calcium oxide fraction can increase the tensile strength and/or the flexural strength of the first filament. Furthermore, an increasing calcium oxide content can improve the surface tension and the density of the inorganic starting material for the first filament in its liquid phase. An increasing calcium oxide content can also increase the tendency to crystallize and improve the chemical resistance of the first filament.

According to a particularly preferred embodiment, the ratio of the aluminum oxide fraction to the magnesium oxide fraction and/or to the calcium oxide fraction of the first filament is greater than or equal to 1.0, preferably greater than or equal to 1.5 and particularly preferably greater than or equal to 2.0.

Tests have shown that the mechanical load-bearing capacity of the first filament can be improved with an increasing ratio of aluminum oxide content to the magnesium oxide content and/or to the calcium oxide content.

Particularly preferably, the first filament is a basalt filament.

In this regard, the following is explained conceptually:

“Basalt” is understood to mean a basalt rock, preferably a naturally occurring basalt rock without chemical additives.

A “basalt filament” is understood to mean an inorganic filament which has basalt to more than 90% per mass or consists of basalt.

Basalt fibers and their production are already known in the prior art, whereby advantages can be achieved in that the production of the co-filament is already well tested at least with respect to the basalt fiber.

Furthermore, basalt already has many of the advantageous substance fractions and/or substance compositions explained above, so that the outlay for producing the inorganic first filament can advantageously be reduced.

Furthermore, basalt is a comparatively cost-effective and readily available raw material, as a result of which the availability through the co-filament increases and the price can decrease. In particular, the fiber production of basalt fibers in comparison to carbon fibers or glass fibers or metal fibers requires significantly less energy.

According to a particularly expedient embodiment, the second filament has an aluminum content of greater than or equal to 98% by mass, preferably an aluminum content of greater than or equal to 99% by mass and particularly preferably an aluminum content of greater than or equal to 99.5% by mass.

Aluminum is a metallic material which has particularly good thermal conductivity and at the same time very good electrical conductivity, whereby these properties can be used particularly advantageously for the co-filament proposed here.

Moreover, aluminum has very good deformability, so that the flexibility of the co-filament can be very well pronounced by the use of aluminum as metal. The good deformability also leads to a reduction of any transverse load on the first filament by deformation forces of the second filament, as a result of which the co-filament can be used more flexibly and the longevity of the co-filament can advantageously be increased.

For this purpose, the use of aluminum still results in the preferably synergistically acting effect that the adhesion between the aluminum on the first filament, in particular by the chemical connection with the aluminum oxide, can be improved compared to other metals.

In addition, the comparatively low melting point of aluminum at approximately 660° C. enables the first filament to have a comparatively low glass transition temperature for the production of the co-filament.

The good corrosion resistance of aluminum further increases the flexibility of the possible designated usage environments for the co-filament.

It should be explicitly pointed out that the above values for the aluminum content of the second filament should not be understood as strict limits; rather, it should be possible to exceed or fall below them on an engineering scale without departing from the described aspect of the invention. In simple terms, the values are intended to provide an indication of the size of the range proposed here of the aluminum content of the second filament

According to an optional embodiment, the second filament has a copper content of greater than or equal to 98% by mass, preferably a copper content of greater than or equal to 99% by mass and particularly preferably a copper content of greater than or equal to 99.5% by mass. Further preferably, the second filament has a copper content of greater than or equal to 90% by mass, preferably a copper content of greater than or equal to 94% by mass and particularly preferably a copper content of greater than or equal to 96% by mass.

Particularly preferably, the second filament consists essentially of copper, preferably the second filament consists of copper and has impurities only to a lesser extent.

Optionally, the first filament has a round or an angular cross-sectional area.

Here, among other things, it is intended that the first filament produced with a nozzle method or a spinning method has a round cross section, in particular an oval cross section, or an angular cross section, in particular a square cross section, a rectangular cross section, a hexagonal cross section or an n-angular cross section. Furthermore, composite cross-sectional shapes are also intended which are composed of at least two of the aforementioned basic forms.

It is also intended here that the shape of the second filament is adapted to the shape of the first filament. If the first filament has a round cross section, a sickle-shaped shape or a shape of a hollow cylinder or a likewise round or oval shape is preferably intended for the second filament. If the first filament has a rectangular shape, it is also preferably intended for the second filament to have a rectangular shape or a sickle-like shape partially enclosing the first filament or a round or oval shape or a hollow body which completely surrounds the first filament. The same is also conceivable in adapted form in general for a first filament with n-angular cross-section. In other words, the second filament in the contact region to the first filament has a shape adapted to the first filament and corresponding to the first filament.

On the side facing away from the first filament, the second filament preferably has a curvilinear shape, which is preferably caused during the production of the co-filament by the surface tension of the temporarily fusible metallic substance.

According to a preferred embodiment, the first filament has a transverse extension in a range of greater than or equal to 3.5 μm to less than or equal to 25 μm, preferably a transverse extent in a range of greater than or equal to 10 μm to less than or equal to 20 μm and particularly preferably a transverse extent in a range of greater than or equal to 11 μm to less than or equal to 18 μm.

Further preferably, the first filament has a transverse extension in a range of greater than or equal to 11 μm to less than or equal to 16 μm, preferably a transverse extent in a range of greater than or equal to 12 μm to less than or equal to 15 μm and particularly preferably a transverse extent in a range of greater than or equal to 12 μm to less than or equal to 14 μm.

In this regard, the following is explained conceptually:

A “transverse extension” is understood to mean the extension of a filament transverse to the longitudinal extension direction of the filament, in particular the extension of the first filament transversely to the longitudinal extension direction of the first filament or the extension of the co-filament transversely to the longitudinal extent direction of the co-filament.

The values given above for the transverse extension of the first filament enable an optimal formation of the material properties of the co-filament for a plurality of application cases in conjunction with a preferably likewise optimized geometry of the second filament.

It should be expressly noted that the above values for the transverse extension of the first filament should not be understood as strict limits; rather, it should be possible to exceed or fall below them on an engineering scale without departing from the described aspect of the invention. In simple terms, the values are intended to provide an indication of the size of the range proposed here of the transverse extension of the first filament.

Preferably, the second filament has a maximum wall thickness of less than or equal to 200 μm, preferably a maximum wall thickness of less than or equal to 160 μm and particularly preferably a maximum wall thickness of less than or equal to 130 μm.

Further preferably, the second filament has a maximum wall thickness of less than or equal to 100 μm, preferably a maximum wall thickness of less than or equal to 75 μm and particularly preferably a maximum wall thickness of less than or equal to 50 μm. Further preferably, the second filament has a maximum wall thickness of less than or equal to 30 μm, preferably a maximum wall thickness of less than or equal to 20 μm and particularly preferably a maximum wall thickness of less than or equal to 15 μm. Further preferably, the second filament has a maximum wall thickness of less than or equal to 10 μm, preferably a maximum wall thickness of less than or equal to 8 μm and particularly preferably a maximum wall thickness of less than or equal to 5 μm. Particularly preferably, the second filament has a maximum wall thickness of less than or equal to 1 μm, preferably a maximum wall thickness of less than or equal to 0.1 μm and particularly preferably a maximum wall thickness of less than or equal to 0.01 μm.

According to an expedient embodiment, the second filament, wherein the second filament completely surrounds the first filament, has a wall thickness, in particular a maximum material thickness of the second filament, of less than or equal to 30 μm, preferably a maximum wall thickness of less than or equal to 20 μm and particularly preferably a maximum wall thickness of less than or equal to 15 μm. Further preferably, the second filament has a wall thickness of less than or equal to 8 μm, preferably a maximum wall thickness of less than or equal to 5 μm and particularly preferably a maximum wall thickness of less than or equal to 2 μm.

In this regard, the following is explained conceptually:

A “maximum wall thickness” is understood to mean the maximum wall thickness of the filament, in particular of the second filament, of a defined cross section.

Particularly preferably, the second filament has a maximum wall thickness of greater than or equal to 0.2 μm, preferably a maximum wall thickness of greater than or equal to 0.5 μm and particularly preferably a maximum wall thickness of greater than or equal to 1 μm.

Further particularly preferably, the second filament has a maximum wall thickness of greater than or equal to 1.5 μm, preferably a maximum wall thickness of greater than or equal to 2 μm and particularly preferably a maximum wall thickness of greater than or equal to 3 μm.

Tests have found that the maximum wall thickness of the second filament specified above allows a very good compromise between material requirement and achievable properties of the co-filament with regard to its maximum values and/or with respect to its minimum values, in particular also with regard to a preferably optimized transverse extension of the first filament.

It should be expressly noted that the above values for the maximum wall thickness of the second filament are not intended to be sharp limits, but rather are intended to be capable of being exceeded or undershot on an engineering scale without departing from the aspect of the invention described. In simple terms, the values are intended to provide an indication of the size of the range proposed here of the maximum wall thickness of the second filament.

According to a preferred embodiment, the co-filament has a maximum transverse extent in a range of greater than or equal to 10 μm to less than or equal to 55 μm, preferably a maximum transverse extent in a range of greater than or equal to 10 μm to less than or equal to 40 μm and particularly preferably a maximum transverse extent in a range of greater than or equal to 11 μm to less than or equal to 35 μm.

Furthermore, according to a preferred embodiment, the co-filament has a maximum transverse extent in a range of greater than or equal to 11 μm to less than or equal to 30 μm, preferably a maximum transverse extent in a range of greater than or equal to 12 μm to less than or equal to 25 μm and particularly preferably a maximum transverse extent in a range of greater than or equal to 12 μm to less than or equal to 20 μm. Preferably, the co-filament has a maximum transverse extent in a range of greater than or equal to 12 μm to less than or equal to 18 μm, preferably a maximum transverse extent in a range of greater than or equal to 13 μm to less than or equal to 17 μm and particularly preferably a maximum transverse extent in a range of greater than or equal to 14 μm to less than or equal to 16 μm.

Particularly preferably, the maximum transverse extension of the co-filament is less than or equal to 18 μm.

With regard to an application analysis, it was found that the above values for the maximum transverse extent of the co-filament are particularly advantageous for the majority of the applications.

Overall, it is thereby possible to achieve a particularly thin filament which simultaneously has novel material properties. Thin filaments enable, in particular, a filtration of particularly fine particles.

It should be expressly noted that the above values for the maximum transverse extension of the co-filament are not intended to be sharp limits, but rather are intended to be capable of being exceeded or undershot on an engineering scale without departing from the aspect of the invention described. In simple terms, the values are intended to provide a guide to the size of the range of the maximum transverse extension of the co-filament proposed here.

According to an optional embodiment, a contact area between the first filament and the second filament is greater than or equal to 1% of the circumference of the first filament, preferably greater than or equal to 5% of the circumference of the first filament and particularly preferably greater than or equal to 10% of the circumference of the first filament.

Preferably, a contact area between the first filament and the second filament is greater than or equal to 20% of the circumference of the first filament, preferably greater than or equal to 30% of the circumference of the first filament and particularly preferably greater than or equal to 40% of the circumference of the first filament. Furthermore, a contact area between the first filament and the second filament is preferably greater than or equal to 50% of the circumference of the first filament, preferably greater than or equal to 60% of the circumference of the first filament and particularly preferably greater than or equal to 70% of the circumference of the first filament. Particularly preferably, a contact area between the first filament and the second filament is greater than or equal to 80% of the circumference of the first filament, preferably greater than or equal to 90% of the circumference of the first filament and particularly preferably equal to 100% of the circumference of the first filament.

In this regard, the following is explained conceptually:

The “contact region” is understood to mean the contact line between the first filament and the second filament.

Optionally, a contact area between the first filament and the second filament is less than or equal to 95% of the circumference of the first filament, preferably less than or equal to 90% of the circumference of the first filament and particularly preferably less than or equal to 85% of the circumference of the first filament. Preferably, a contact area between the first filament and the second filament is smaller than or equal to 75% of the circumference of the first filament, preferably smaller than or equal to 65% of the circumference of the first filament and particularly preferably smaller than or equal to 55% of the circumference of the first filament.

As a result of the size of the contact region, a compromise between the material requirement for the second filament and the material properties of the co-filament can advantageously be optimized.

It should be explicitly pointed out that the above values for the contact region between the first filament and the second filament should not be understood as strict limits; rather, it should be possible to exceed or fall below them on an engineering scale without departing from the described aspect of the invention. In simple words, the values are intended to provide an indication for the size of the region of the contact region proposed here between the first filament and the second filament.

According to a second aspect of the invention, the task is solved by a roving comprising a co-filament according to the first aspect of the invention.

In this regard, the following is explained conceptually:

A “roving” is understood to mean a bundle of several co-filaments to form a strand, in particular a bundle of co-filaments arranged in parallel.

It should be understood that the advantages of a co-filament according to the first aspect of the invention, as described above, extend directly to a a roving comprising co-filaments according to the first aspect of the invention.

It should be expressly noted that the subject matter of the second aspect can advantageously be combined with the subject matter of the preceding aspect of the invention, both individually or cumulatively in any combination.

According to a second aspect of the invention, the task is solved by a a yarn comprising a co-filament according to the first aspect of the invention.

In this regard, the following is explained conceptually:

A “yarn” is understood to mean a bundle of several co-filaments to form a strand, with rotations being applied to the co-filaments of the yarn about the longitudinal axis of the yarn. In particular, a yarn has a ratio of yarn length to yarn diameter of greater than or equal to 100.

It should be understood that the advantages of a co-filament according to the first aspect of the invention, as described above, extend directly to a yarn comprising co-filaments according to the first aspect of the invention.

It should be expressly noted that the subject matter of the third aspect can advantageously be combined with the subject matter of the preceding aspects of the invention, both individually or cumulatively in any combination.

Preferably, the task solves a short cut fiber or a long cut fiber, wherein the short cut fiber or the long cut fiber has a cut co-filament according to the first aspect of the invention or a cut roving according to the second aspect of the invention or a cut yarn according to the third aspect of the invention.

A “short cut fiber” is understood to mean a fiber which has been produced by cutting from a co-filament according to the first aspect of the invention or a roving according to the second aspect of the invention or a yarn according to the third aspect of the invention, wherein a short cut fiber has a length of less than or equal to 6 mm.

A “long-cut fiber” is understood to mean a fiber which has been produced by cutting from a co-filament according to the first aspect of the invention or a roving according to the second aspect of the invention or a yarn according to the third aspect of the invention, wherein a long-cut fiber has a length of less than or equal to 60 mm and longer than 6 mm.

According to a third aspect of the invention, the object is achieved by semi-finished product comprising a co-filament according to the first aspect of the invention and/or comprising a roving according to the second aspect of the invention.

In this regard, the following is explained conceptually:

A “semi-finished product” or also a “textile semi-finished product” is understood to mean a raw material made from co-filaments, in particular a textile, wherein the prefabricated raw material preferably has the co-filament in a basic geometric shape. A textile or a textile semi-finished product can be fiber-based, in particular a nonwoven. A textile or a textile semi-finished product can be textile-based, in particular a knitted fabric, preferably a knitted fabric or interlaced yarns. Textile or a textile semi-finished product can be textile-based, in particular an extended thread system, preferably a non-crimp fabric or a tape. Textile or a textile semi-finished product can be textile-based, in particular a crossed thread system, preferably a woven fabric or a mesh.

Preferably, a semi-finished product is understood to mean a short-cut fiber or a long-cut fiber, wherein the short-cut fiber or the long-cut fiber has a cut co-filament according to the first aspect of the invention or a cut roving according to the second aspect of the invention or a cut yarn according to the third aspect of the invention.

Further preferably, a nonwoven is understood to mean a semi-finished product which is made up of short-cut fibers and/or of long-cut fibers, wherein the short-cut fiber and/or the long-cut fiber has a cut co-filament according to the first aspect of the invention or a cut roving according to the second aspect of the invention or a cut yarn according to the third aspect of the invention.

Semi-finished products comprising the co-filament according to the first aspect of the invention can represent an excellent Alternative to solid metal plates for shielding against electromagnetic waves, whereby the weight of a shield can be drastically reduced. This is particularly relevant in the field of mobility.

It should be understood that the advantages of a co-filament according to the first aspect of the invention, as described above, extend directly to a semi-finished product comprising co-filaments according to the first aspect of the invention.

It should be expressly noted that the subject matter of the fourth aspect is advantageously combinable with the subject matter of the preceding aspect of the invention, both individually or cumulatively in any combination.

According to a fifth aspect of the invention, the object is achieved by using a co-filament according to the first aspect of the invention for conducting electrical currents and/or for conducting heat and/or for shielding electromagnetic waves and/or as a component of an antenna. Thus, in particular in the case of use of the co-filament for an antenna, due to the particularly good electrical conductivity of the co-filament, it can advantageously be achieved that the co-filament derives an electromagnetic pulse from the antenna, in particular in the case of an electromagnetic pulse with a low frequency. As a result, the antenna can be effectively protected against an electromagnetic pulse.

The co-filament according to the first aspect of the invention has, among other things, advantages with regard to its electrical and/or thermal conductivity and/or its tensile strength and/or its temperature resistance and/or its chemical resistance and/or its porosity and/or its drapability and/or its antiviral effect and/or its flame resistance.

These advantages can be used in a large number of different applications for improving the functionality of products. Among other things, the use of the co-filament for a battery housing, a conductor track, in particular for the connection of sensors and/or actuators and/or current sources in textiles, preferably for heating a smart textile, in particular a ski sock and/or a winter jacket, and/or for electromagnetic shielding of a smart textile, in particular a poncho and/or maternity wear and/or work clothing, and/or for the current dissipation of a filter, in particular of a heavy oil filter and/or for improving the filtration effect, in particular in an air filter, and/or for an electromagnetic screening plate, in particular for CT rooms and/or the EMP protection and/or for a server room, and/or for an electromagnetic shielding sector, in particular for the EMP protection and/or for a server room, and/or for an electromagnetic shielding sector, in particular for the EMP protection and/or for a server room, and/or as a reinforcing fiber for metallic objects, in particular for an aluminum rim and/or an aluminum body and/or for a component made of cast aluminum and/or the like, and/or as a composite aid, in particular for textile concrete and/or a composite aid, should be specifically used here organo sheet and/or the like, and/or for protective clothing, in particular for antiviral clothing and/or for a protective mask and/or for a firefighting clothing and/or the like, and/or for a sensor system, in particular for an antenna and/or a structural monitoring and/or a measured value acquisition, and/or for a dipole, in particular for an antenna and/or a decoy, and/or for an insulation, in particular for an insulation body and/or a reflector.

It should be understood that the advantages of a co-filament according to the first aspect of the invention, as described above, extend directly to the use of a co-filament according to the first aspect of the invention.

It should be expressly noted that the subject matter of the fifth aspect is advantageously combinable with the subject matter of the preceding aspect of the invention, both individually or cumulatively in any combination.

According to a sixth aspect of the invention, the object solves a method of production of a co-filament according to the first aspect of the invention, comprising the following steps:
Forming the first filament with a nozzle manufacturing method or a spinning method; and
At least partially coating the first filament with the second filament.

Here, a tool for producing a battery shell according to the first aspect of the invention is proposed.

Among other things, in the method proposed here, it is intended that the coating of the first filament with the second filament takes place by contacting the first filament with a molten metal, wherein the first filament is guided along its longitudinal extension direction via the contact point. As a result, the molten metal adheres to the first filament, is carried along by it in its direction of movement, transitions into the solid state of matter and thus forms the second filament adhering to the first filament, in particular the second filament contacted with the first filament.

The first filament can be pulled out of the melt with the second filament before coating.

Preferably, the first filament is contacted with the molten metal material, preferably after the first filament has fallen below its glass transition temperature, the first filament preferably has a temperature above the melting temperature of the metallic substance at the time of contact. The contacting of the inorganic first filament with the molten metal is possible, in particular, since the contact time between the inorganic first fiber and the molten metal material takes place in the range of a few milliseconds. It can preferably be achieved by the short contact time proposed here that a material property of the inorganic fiber is not impaired by the effect of the temperature of the molten metal substance.

It is proposed here that the first filament is connected to the metallic material at a contact lip. Since the metallic material is molten in the region of the contact lip, it is intended, among other things, to form the lip from a material which is present as a solid body above the melting temperature of the metal material. In particular, a lip made of ceramic, which is wetted with the metallic material, is intended here, so that the first filament can be contacted with the metallic material adjacent to the lip.

According to an expedient embodiment, it is intended that the lip vibrate during the production of the co-filament. As a result, a continuous flow behavior of the molten metal material can advantageously be improved, whereby smaller layer thicknesses and/or more homogeneous layer thicknesses of the second filament, in particular a smaller maximum wall thickness and/or a more homogeneous maximum wall thickness of the second filament, can be achieved.

Tests have shown that the co-filament can preferably be produced at a velocity in a range of greater than or equal to 500 m/min to less than or equal to 4,000 m/min, preferably at a rate in a range of greater than or equal to 2,500 m/min to less than or equal to 1,300 m/min and particularly preferably at a rate in a range from greater than or equal to 900 m/min to less than or equal to 1,500 m/min. As a result, the productivity can advantageously be increased compared to the prior art, so that produced fibers can be produced cost-effectively.

Preferably, the co-filament is wound up with the second filament after the at least partial coating of the first filament.

It should be expressly noted that the subject matter of the sixth aspect is advantageously combinable with the subject matter of the preceding aspect of the invention, both individually or cumulatively in any combination.

Further advantages, details and features of the invention can be found below in the described embodiments. In the drawings, in detail:

FIG. 1: shows schematically a first embodiment of a co-filament;

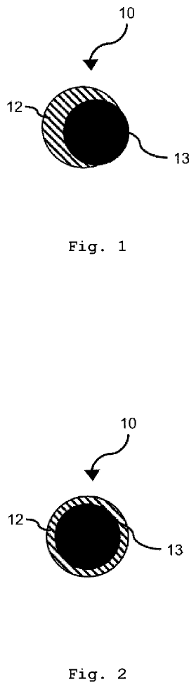

FIG. 2: shows schematically a second embodiment of a co-filament;

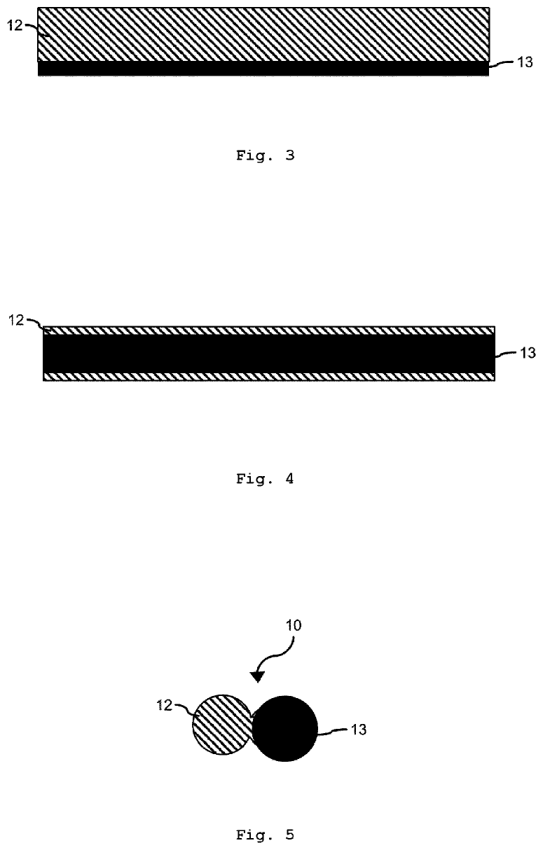

FIG. 3: schematically a cross section in the longitudinal direction of the first embodiment of a co-filament;

FIG. 4: schematically a cross section in the longitudinal direction of the second embodiment of a co-filament;

FIG. 5: shows schematically shows a third embodiment of a co-filament;

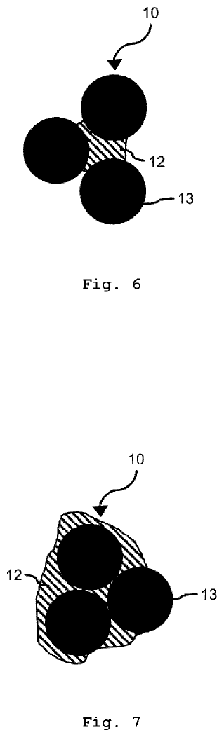

FIG. 6: shows schematically a fourth embodiment of a co-filament;

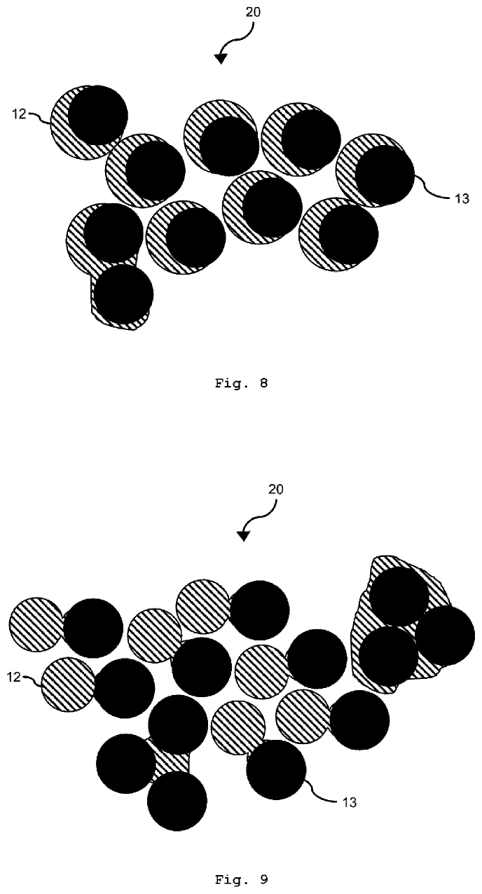

FIG. 7: shows schematically a fifth embodiment of a co-filament;

FIG. 8: shows schematically a first embodiment of a yarn; and

FIG. 9 shows schematically a second embodiment of a yarn.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The co-filament 10 according to a first embodiment in FIG. 1 and FIG. 3 consists essentially of a first filament 13 made of an inorganic material and a second filament 12 made of a metal material.

The first filament 13 has a glass transition temperature of greater than or equal to 4,000° C.

The second filament 12 is crescent-shaped and contacts the first filament 13.

The co-filament 10 according to a second embodiment in FIG. 2 and FIG. 4 consists essentially of a first filament 13 made of an inorganic material and a second filament 12 made of a metal material.

The second filament 12 forms a homogeneous sheath with preferably constant wall thickness around the first filament 13.

The co-filament 10 according to a third embodiment in FIG. 5 is formed by a comparatively small contact region between the first filament 13 and the second filament 12, so that the individual filaments 12, 13 are arranged next to one another in pairs.

The co-filament 10 according to a fourth embodiment in FIG. 6 has three first filaments 13, which are connected to one another by a common second filament 12. A co-filament 10 according to the fourth embodiment is preferably brought about by fusing the metallic second filament 12 of three co-filaments 10 of the first and/or second and/or third embodiment together.

The co-filament 10 according to a fifth embodiment in FIG. 7 has three first filaments 13, which are connected to one another by a common second filament 12. It can preferably be obtained like a co-filament 10 of the fourth embodiment.

A yarn 20 according to a first embodiment in FIG. 8 or a yarn 20 according to a second embodiment in FIG. 9 consists of a plurality of co-filaments 10 according to the first and/or second and/or third and/or fourth and/or fifth embodiment.

### LIST OF REFERENCE SIGNS

10 co-filament
12 second filament
13 first filament
20 yarn

1. Co-filament comprising a first filament and a second filament, the first filament consisting of an inorganic substance, the first filament having a glass transition temperature of greater than or equal to 400° C., the second filament being made of a metallic material, the second filament contacting the first filament.

2. Co-filament according to claim 1, wherein the first filament has a glass transition temperature of greater than or equal to 660° C., preferably a glass transition temperature of greater than or equal to 800° C. and particularly preferably a glass transition temperature of greater than or equal to 1000° C.

3. Co-filament according to claim 1, wherein the first filament has a bound oxygen content of greater than or equal to 30% by mass, preferably a bound oxygen content of greater than or equal to 40% by mass and particularly preferably a bound oxygen content of greater than or equal to 44% by mass.

4. Co-filament according to claim 1, wherein the first filament has a silica fraction of greater than or equal to 45% by mass, preferably a silica fraction of greater than or equal to 50% by mass and particularly preferably a silica fraction of greater than or equal to 55% by mass.

5. Co-filament according to claim 1, wherein the first filament has an aluminum oxide content of greater than or equal to 12% by mass, preferably an aluminum oxide content of greater than or equal to 14% by mass and particularly preferably an aluminum oxide content of greater than or equal to 16% by mass.

6. Co-filament according to claim 1, wherein the first filament has a boron trioxide content of less than or equal to 0.5 mass %, preferably a boron trioxide content of less than or equal to 0.1 mass % and particularly preferably a boron trioxide content of less than or equal to 0.01 mass %.

7. Battery cooling element according to claim 1, wherein the first filament is a basalt filament.

8. Co-filament according to claim 1, wherein the second filament has an aluminum content of greater than or equal to 98% by mass, preferably an aluminum content of greater than or equal to 99% by mass and particularly preferably an aluminum content of greater than or equal to 99.5% by mass.

9. Co-filament according to claim 1, wherein the first filament has a round or an angular cross-sectional area.

10. Co-filament according to claim 1, wherein the first filament has a transverse extension in a range of greater than or equal to 10 μm to less than or equal to 25 μm, preferably a transverse extension in a range of greater than or equal to 10 μm to less than or equal to 20 μm and particularly preferably a transverse extension in a range of greater than or equal to 11 μm to less than or equal to 18 μm.

11. Co-filament according to claim 1, wherein the second filament has a maximum wall thickness of less than or equal to 30 μm, preferably a maximum wall thickness of less than or equal to 20 μm and particularly preferably a maximum wall thickness of less than or equal to 15 μm.

12. Co-filament according to claim 1, wherein the second filament has a maximum wall thickness of greater than or equal to 0.2 μm, preferably a maximum wall thickness of greater than or equal to 0.5 μm and particularly preferably a maximum wall thickness of greater than or equal to 1 μm.

13. Co-filament according to claim 1, wherein the co-filament has a maximum transverse extension in a range of greater than or equal to 10 μm to less than or equal to 55 μm, preferably a maximum transverse extent in a range of greater than or equal to 10 μm to less than or equal to 40 μm and particularly preferably a maximum transverse extent in a range of greater than or equal to 11 μm to less than or equal to 35 μm.

14. Co-filament according to claim 1, wherein a contact area between the first filament and the second filament is greater than or equal to 5% of the circumference of the first filament, preferably greater than or equal to 10% of the circumference of the first filament and particularly preferably greater than or equal to 15% of the circumference of the first filament.

15. Co-filament according to claim 1, wherein a contact area between the first filament and the second filament is less than or equal to 95% of the circumference of the first filament, preferably less than or equal to 90% of the circumference of the first filament and particularly preferably less than or equal to 85% of the circumference of the first filament.

16. Roving comprising a co-filament according to claim 1.

17. Yarn comprising a co-filament according to claim 1.

18. Semi-finished product comprising a co-filament according to claim 1.

19. Use of a co-filament according to claim 1 for conducting electrical currents and/or for conducting heat and/or for shielding electromagnetic waves and/or as a component of an antenna.

20. Method for producing a co-filament according to claim 1, comprising the following steps:
Forming the first filament with a nozzle drawing manufacturing method or a spinning method; and
At least partial coating of the first filament with the second filament.
